(19) United States
(12) Patent Application Publication
(10) Pub. No.: US 2009/0219389 A1
(43) Pub. Date: Sep. 3, 2009

(54) Detection of Smoke with a Video Camera

(75) Inventor: Giuseppe Marbach, Hombrechtikon (CH)

Correspondence Address: LERNER GREENBERG STEMER LLP, P O BOX 2480, HOLLYWOOD, FL, 33022-2480, US

(73) Assignee: SIEMENS SCHWEIZ AG, Zurich (CH)

(21) Appl. No.: 12/095,937

(22) PCT Filed: Sep. 25, 2006
(86) PCT No.: PCT/EP2006/066718

§ 371 Date: Oct. 15, 2008

(51) Int. Cl. H04N 7/18; G06K 9/00

(52) U.S. Cl. 348/143; 382/103; 348/E07.085

(57) ABSTRACT

A method and an apparatus for detecting smoke by way of analysis of at least one video image recorded by a video camera monitoring an area. At least one moving area of the at least one video image is tested for the probable presence of smoke by determining the direction and the size of the moving area. If the test result is positive, at least part of the at least one moving area is evaluated with respect to the presence of smoke as a function of at least one item of information that is characteristic of smoke.

The invention relates to a method and a device for detection of smoke by analysis of at least one video image recorded by a video camera monitoring an area.

In recent times there have been efforts made to make use of the video systems available in any event for security monitoring in buildings, tunnels etc. for detection of smoke. Since the video images are very often of little interest to an observer and in addition smoke would only make small changes to the video image, there is no question of monitoring by the personnel at the screens. If it can be done at all, the monitoring can only be undertaken by an automatic evaluation of the video images. With a known method for automatically investigating video images for the occurrence of smoke the intensity values of the individual pixels in consecutive images are compared to one another. If intensity values are measured which are representative of a brighter image caused by the presence of smoke, it is concluded that smoke is present and an alarm is triggered.

One of the problems which arises with this method is that smoke is not detected against a bright background and even fire which generates only a little smoke is not detectable. In addition changes in brightness, as might be caused for example by a person moving through the field of view of the camera, can trigger a false alarm. Attempts have been made to resolve this problem by investigating a further outer area in addition to the actual monitoring area and, on changes in this outer area, interrupting the observation of the monitoring area. The disadvantage of this method is that a fire is not detected in certain circumstances until after a certain delay, and that sources of smoke in the outer area provided in addition to the monitoring area are not detected.

The object of the present invention is to be seen as proposing an efficient option for the detection of smoke by means of at least one video image recorded by a video camera monitoring an area.

The inventive object is achieved in each case by the subject matter of the independent claims. Further developments of the invention are specified in the subclaims.

A key element of the invention is to be seen as the detection of smoke by analysing at least one video image recorded by a video camera monitoring an area. An area in such cases can be a room, a tunnel (section), a car park, a street or a section of a street etc. Basically a first step checks, by determining the direction and the size for a moving area of the at least one video image, a probability of smoke being present in the moving area. If a moving area yields a positive test result, there is thus a degree of probability that smoke is present. Thereafter at least a part of the moving area is evaluated for the presence of smoke, depending on at least one item of information characteristic for smoke. Inventively information characteristic of smoke is seen as the speed of the smoke, the number of pixels in the video image which describe this movement, the luminance change (brightness change) of the at least one video image in relation to the background, the change of colour of the moving smoke and the movement of the smoke.

An advantage of the inventive method or the inventive device is to be seen as the ability to detect smoke in an efficient manner. This is obtained particularly by the two-part evaluation and by the suitable selection of the characteristic information for the smoke.

The invention will be explained in greater detail on the basis of an exemplary embodiment shown in a figure. The figures show

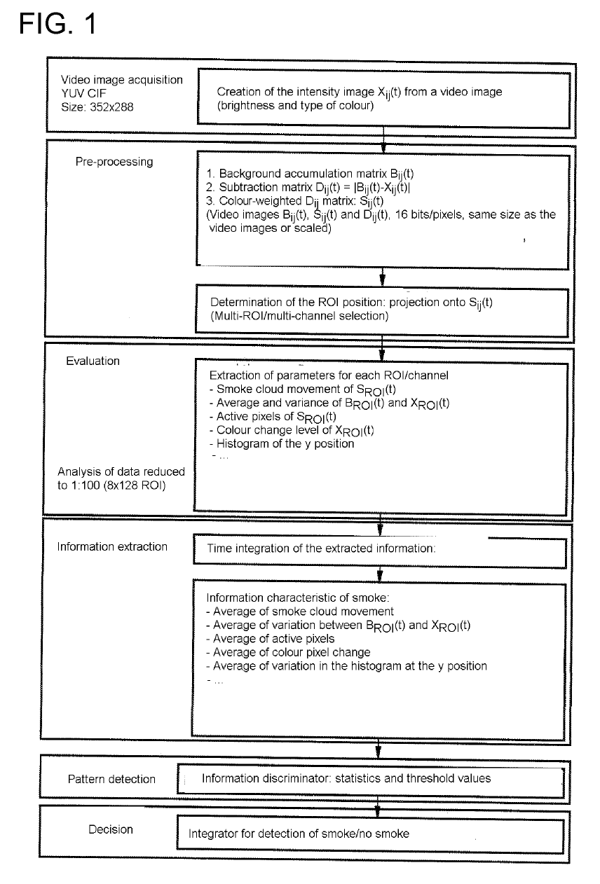

FIG. 1 a block diagram according to the invention for detection of smoke,

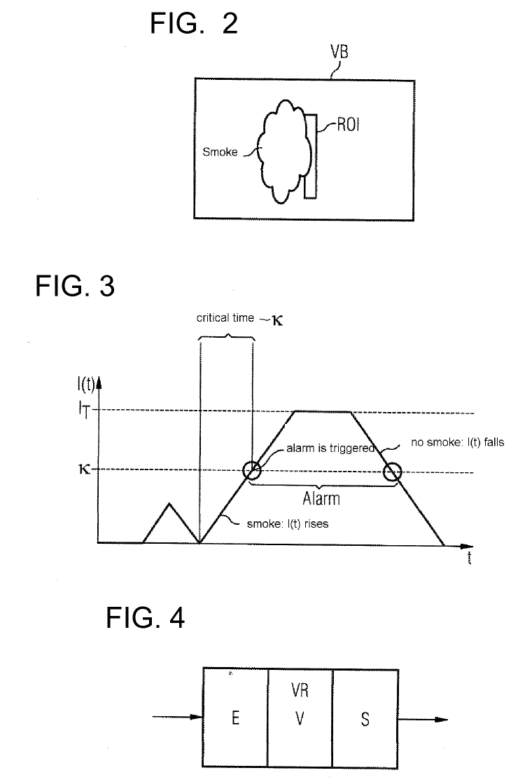

FIG. 2 a simplified presentation of a video image,

FIG. 3 a decision diagram for the detection of smoke,

FIG. 4 an inventive device.

FIG. 1 shows a block diagram in accordance with the invention for detection of smoke. At least one intensity image [Xᵢⱼ(t)] is obtained from at least one video image, which was created with a particular frequency. The video image can in this case have a size of 352×288 pixels for example. The next step is pre-processing. The aim of the pre-processing is that the areas which are of interest for the detection of smoke are filtered out of the video image. To this end a background accumulation matrix [Bᵢⱼ(t)] is first created. The background accumulation matrix [Bᵢⱼ(t)] is obtained from the intensity images [Xᵢⱼ(t)] weighted with a weighting factor, with the weighting factor specifying how strongly the intensity images flow into the accumulation matrix [Bᵢⱼ(t)]

The accumulation matrix is determined as follows:

Bij(t)=αBij(t−1)+(1−α)Xij(t), α=weighting factor

Next a subtraction matrix Dᵢⱼ(t)=/Bᵢⱼ(t)−Xᵢⱼ(t)/is computed for at least one moving area. Finally the colour-weighted subtraction matrix [Sᵢⱼ(t)] is obtained from the colour weighting of the subtraction matrix Dᵢⱼ(t).

This subtraction matrix [Sᵢⱼ(t)] is computed from

Sᵢⱼ(t)=Luma{Dᵢⱼ(t)}×{1−|ChromaU{Dᵢⱼ(t)}−ChromaV{Dᵢⱼ(t)}|},

with Luma {Dᵢⱼ} being the luma component of Dᵢⱼ, ChromaU (Dᵢⱼ) the U-chroma component of Dᵢⱼ and ChromaU (Dᵢⱼ) the V-chroma component of Dᵢⱼ.

The probable presence of smoke at location (i, j) is finally determined for example by the projection of the colour-weighted subtraction matrix [Sᵢⱼ(t)] onto the x/y axis of a Cartesian coordinate system.

The projection onto a Cartesian coordinate system appears as follows:

[iₘ,jₘ](t)={(i,j)|i=max {x projection of Sᵢⱼ(t)},

j=max {y projection of Sᵢⱼ(t)}}

x projection of Sᵢⱼ(t): Pₓᵢ(t)=Sᵢ₀(t)+Sᵢ₁(t)+Sᵢ₂(t)+ . . . +S_{IV}(t)
y-projection of Sᵢⱼ(t): p_{yj}(t)=S₀ⱼ(t)+S₁ⱼ(t)+S₂ⱼ(t)+ . . . +S_{Hj}(t)

The size of Sᵢⱼ in this example is H×V (H=speed of the smoke×the movement of the smoke=V). Obviously any given coordinate system can be chosen. Thus spherical coordinates, cylindrical coordinates etc. could also be used for example.

A probable presence of smoke in a moving area of the video image can then be checked with the aid of the colour-weighted subtraction matrix [Sᵢⱼ(t)]. For a probable presence of smoke a region of interest (ROI) in the video image reduced by comparison with the original image is defined. Obviously more than one ROI can be defined in a video image or for a number of channels. By reducing the data to around 1:100, the size of the ROI can in such cases be 8×128 pixels for example; the processor load for the actual analysis or evaluation is significantly reduced. Whether smoke is present in a moving area of the recorded video image is clarified with reference to at least one item of characteristic information for smoke. In the present example the five following items of information are used to increase the security of detection.

Viewed as characteristic information for smoke are the speed of the smoke (movement of the smoke), the number of pixels (active pixels) which describe this movement, the luminance change of the at least one video image in relation to the background, the colour change of the moving smoke and the movement of the smoke (y position in the histogram).

The following information characteristic of smoke is now computed for each ROI:
The smoke movement of SROI(t): v(t)=time correlation of the y-projection of SROI (t), for example pyj(t),
The variance of BROI(t) and XROI (t), which is used for determining the change in brightness relative to the (normal) background: 1(t)=1−var{BROI (t)}/var{BROI (t)},
Active pixels of S_{ROI} (t): a(t)=number of pixels of S_{ROI}(t) with a value greater than 0,
Colour change: c(t)=number of pixels with {1|ChromaU (D_{ROI}(t))−ChromaV (D_{ROI} (t) 1}<threshold value,
y position in the histogram: h(t)=values of the y-projection of S_{ROI} (t), for example p_{yj}(t) is used to create a histogram with 64 channels.

Thereafter the information characteristic for smoke v(t), l(t), a(t), c(t) and h(t) is integrated over a specific time and thereby over a number of images. The function appears as follows for example:

$${F}_{x} = X = {\sum }_{{t}_{0} < t < {t}_{n}} x ( t )$$

$$with$$

$$X = V , L , A , C , H$$

The respective average is determined for the information integrated over time.

Average of smoke movement F_{V}=V
Average of brightness change F_{L}=L
Average of active pixels F_{A}=A
Average of colour change F_{C}=C
Average of y position in the histogram F_{H}=H

Thereafter the probability of the presence of smoke is computed for each of these averages. This is done by pattern detection. For each average a discriminator value Ψ is determined. A threshold value δ (or also a probability function) can for example define the discriminator in the following manner: for the change in brightness

$${Ψ}_{L} = Γ ( {F}_{L} ) = \{ \begin{matrix}{F}_{L} > {δ}_{L} , & then {ψ}_{L} = 1 \\ {F}_{L} > {δ}_{L ,} & then {ψ}_{L} = 0\end{matrix}$$

or 0≦Γ(F_{L})≦1, with Γ(x) as probability function The smoke pattern is defined by the product of all discriminators

$$ℵ ( t ) = {\prod }_{i = Information} Ψ i = \{ {Ψ}_{v} \cdot {Ψ}_{L} \cdot {Ψ}_{A} \cdot {Ψ}_{C} \cdot {Ψ}_{H} \}$$

or as the average of all discriminators

$$ℵ ( t ) = 1 / {N}_{F} {\sum }_{i = Information} Ψ i = \{ {Ψ}_{v} + {Ψ}_{L} + {Ψ}_{A} + {Ψ}_{C} + {Ψ}_{H} \} / {N}_{F}$$

with N_{F}=5 being the number of items of information.

Finally the decision is made as to whether the moving area of the video image involves an image of smoke. To this end an integrator I(t), which increases or decreases by a value of σ is determined.

| | |
|---|---|
| I(t=0) = 0; | |
| If [symbol] (t) = 1 | then I(t) = I(t−1) + σ ₊ |
| | (added to S₊ if I (t) > S₊) |
| | else I(t) = I(t−1) − σ ₋ |
| | (added to S₋ (usually 0) if I(t) < S₋) |

with σ₊,σ₋ usually assuming the value +1

Smoke is detected and for example an alarm triggered, if I(t) exceeds a critical value K:

| | |
|---|---|
| if I(t) > K | then smoke |
| | else no smoke |

FIG. 2 shows a simplified diagram of a video image VB. The image contains a moving area, which is intended to represent smoke. The video image VB also shows a ROI which has been determined in accordance with the description for FIG. 1.

FIG. 3 shows a decision diagram for the detection of smoke, as described under FIG. 1. If I(t) exceeds a specific threshold value K, an alarm is triggered and it is highly probable that smoke has been detected. So that I(t) does not increase to infinity and thereby the reaction time for smoke detection is unnecessarily reduced, a maximum value I_{T} is defined. The time until an alarm is triggered is designated as the critical time. This time should be as short as possible.

FIG. 4 shows an inventive device VR with a receiver unit E and a transmitter unit S for communicating for example with other units such as sensors, central units etc. and a processing unit V to execute the method in accordance with FIG. 1. In such cases the device can be integrated into a video camera, a central unit etc. or can represent a separate unit.

1-15. (canceled)

16. A method of detecting smoke, which comprises:
recording at least one video image with a video camera monitoring a given area;
checking at least one moving area of the at least one video image for a probable presence of smoke by determining a direction and a size of the moving area; and
if the checking step renders a positive result, evaluating at least a portion of the at least one moving area for a presence of smoke in dependence on one or more items of information characteristic for smoke.

17. The method according to claim 16, which comprises using a speed of movement of the smoke, a number of pixels describing the movement, a luminance change of the at least one video image in relation to the background, a change in color of the moving smoke, and a movement of the smoke as the one or more items of information characteristic for smoke.

18. The method according to claim 16, which comprises generating the at least one video image with a specific frequency, and obtaining therefrom at least one intensity image [Xᵢⱼ(t)].

19. The method according to claim 18, which comprises using a background accumulation matrix [Bᵢⱼ(t)] obtained from intensity images [Xᵢⱼ(t)] weighted with a weighting factor, the weighting factor specifying how strongly the intensity images flow into the accumulation matrix [Bᵢⱼ(t)].

20. The method according to claim 19, which comprises determining at least one moving area with the aid of a subtraction matrix Dᵢⱼ(t)=|Bᵢⱼ(t)−Xᵢⱼ(t)|.

21. The method according to claim 20, which comprises determining a color-weighted subtraction matrix [Sᵢⱼ(t)] from the subtraction matrix [Dᵢⱼ(t)].

22. The method according to claim 21, which comprises checking with the color-weighted subtraction matrix [Sᵢⱼ(t)] for a probable presence of smoke in the moving area of the video image and, if the outcome of the check is positive, defining a region of interest (ROI) in the video image reduced by comparison with an original image.

23. The method according to claim 22, wherein the region of interest (ROI) in the video image represents at least a portion of the moving area of the video image.

24. The method according to claim 22, wherein the region of interest (ROI) in the video image represents a rectangle with a length-to-width ratio of 16:1.

25. The method according to claim 21, which comprises determining the probable presence of smoke at the location (i, j) by projecting the color-weighted subtraction matrix [Sᵢⱼ(t)] onto the x/y axis of a Cartesian coordinate system.

26. The method according to claim 21, which comprises evaluating the at least one item of information characteristic for smoke in the region of interest in the video image.

27. The method according to claim 26, which comprises integrating a signal representing the at least one item of information characteristic for smoke over a specific time and thereby determining a number of images and average values, and computing the probable presence of smoke for each of the average values.

28. The method according to claim 27, which comprises determining a probability of whether smoke is present by comparing with a threshold value δ and/or by way of a probability function Γ(x).

29. The method according to claim 27, which comprises:
computing from the probabilities of the average values an overall probability for the presence of smoke in the region of interest of the video image;
integrating the overall probability over a plurality of images to form an integrated value; and
if a given threshold value is exceeded, triggering an alarm with the integrated value.

30. A device for detecting smoke by analysis of at least one video image recorded by a video camera monitoring a given area, comprising:
a receiver unit and a transmitter unit configured to carry out communication with further units;
a processing unit configured to check for a probable presence of smoke by determining a direction and a size of a moving area in the at least one video image, and, if a positive test result is derived, to evaluate at least a part of the at least one moving area in respect of the presence of smoke in dependence on at least one item of information characteristic of smoke.
